(19) United States
(12) Patent Application Publication
(10) Pub. No.: US 2020/0073655 A1
(43) Pub. Date: Mar. 5, 2020

(54) NON-DISRUPTIVE SOFTWARE UPDATE SYSTEM BASED ON CONTAINER CLUSTER

(71) Applicant: NANUM TECHNOLOGIES CO., LTD., Seoul (KR)

(72) Inventors: Jin Young PARK, Seoul (KR); Byung Eun CHOI, Seoul (KR); Ju Hwi LEE, Anyang-si (KR)

(73) Assignee: NANUM TECHNOLOGIES CO., LTD., Seoul (KR)

(21) Appl. No.: 16/559,840

(22) Filed: Sep. 4, 2019

(30) Foreign Application Priority Data
Sep. 5, 2018 (KR) 10-2018-0106015

(51) Int. Cl. G06F 8/65; G06F 9/455

(52) U.S. Cl. CPC G06F 8/65; G06F 2009/45595; G06F 2009/4557; G06F 9/45558

(57) ABSTRACT

The present invention relates to a technical concept for updating software and performing load balancing for one virtual AI component (nginx) without service interruption based on a reduced system configuration.

The non-disruptive software update system based on a container cluster according to an embodiment performs a software upgrade through a software patch of an AI component (nginx), but a software update processor for monitoring whether a service is stopped while performing the upgrade, Load balancing processing to distribute the load by replicating the application of the AI component (nginx) into a plurality of, and the number of components if the CPU usage observed in the replicated applications increases beyond the reference, the load balancing processing unit If the increase and the CPU usage is lower than the reference may include an auto scaling processor for reducing the number of the duplicated applications.

### TECHNICAL FIELD

### Cross-Reference to Related Application

This application claims priority to Korean Patent Application No. 10-2018-0106015, filed on Sep. 5, 2018 in the Korean Intellectual Property Office, the disclosure of which is incorporated herein by reference.

The present invention relates to a technical concept for updating software and performing load balancing for one virtual AI component (nginx) without service interruption based on a reduced system configuration.

### BACKGROUND ART

Typically, in a large operating environment, servers are configured with multiple physical hosts for redundancy. In a cloud environment, if system is large, it should be able to configure multiple virtual servers (instances) and manage them all at once.

Failures in the backbone systems and mission-critical systems can lead to a significant drop in business credibility as well as missed business opportunities. So even if a system failure occurs, the infrastructure must be configured so that it does not affect the whole system.

Clustering is the technology that keeps the system from shutting down in the event of an emergency. Clustering is a technology that combines multiple servers and hardware as one, and building clustering can improve system performance.

In terms of clustering, availability refers to the ability of a system to run continuously. Even if a server error or hardware failure occurs, it can be converted to another normal server or hardware, and the existing processing can be continued, thereby providing high reliability.

Also, if make multiple computers can avoid bringing the system down under high load.

In addition, it can increase reliability by deploying and distributing multiple computers in a clustered environment to avoid system downtime at high loads. In some cases, cloud virtual servers provide autoscale capabilities. Docker allows it to run Docker on multiple host machines instead of just one to create a highly available and scalable application execution environment.

As such, various tools for clustering containers in a multi-host environment have been developed, and technologies for monitoring a container failure or host machine status are being researched and developed in case of running a container in a multi-host environment.

### RELATED ART DOCUMENTS

### Patent Documents

Korean Patent No. 10-1876918, “Multi Orchestrator Based Container Cluster Service Provision Method”
Korean Patent Application Publication No. 10-2017-0067829, “Method and Apparatus for Mobile Device-Based Cluster Computing Infrastructure)”

### DISCLOSURE

### Technical Problem

The present invention provides a plug and play method for various AI components developed in each section. The goal is to provide an autonomous digital companion framework that can be easily integrated into the system.

The present invention is a concept for the non-disruptive service of the autonomous digital companion framework. The purpose is to perform the verification.

The present invention aims at non-disruptive operation in a software update, load balancing situation except storage and computing in the scope of verification.

The present invention, an autonomous digital companion framework provides a plurality of AI components. It aims to provide an independent and integrated operation management environment by Docker containerizing.

The present invention aims at software update and load balancing of numerous AI components without service interruption.

The present invention aims to proactively verify the possibility of non-disruptive operations for Docker containerized intelligent components.

### Technical Solution

The non-disruptive software update system on container cluster according to an embodiment performs versioning through a software patch of an AI component (nginx), but includes a software update processing unit for monitoring whether the service is interrupted while performing the upgrade, a load balancing processing unit is configured to copy the plurality of applications of the AI component (nginx) to distribute the load and to monitor the load distribution processing and an auto scaling processor configured to increase the number of components when the CPU usage observed in the cloned applications increases above the reference level and to reduce the number of the cloned applications when the CPU usage decreases below the threshold.

The non-disruptive software update system on container cluster according to an embodiment may configure a distributed Docker container operating environment for verification, build a cluster with a container orchestration tool K8s, and perform a load balancing for load balancing after building the cluster, an auto scaling and a rolling update software update for non-disruptive operation.

When the auto scaling processor generates an auto scaler for the AI component (nginx) and applies the minimum number and the maximum number according to the CPU usage by using the generated auto scaler, the CPU is not used. The minimum and maximum number of apply. An uninterrupted software update system based on container clusters that checks and adjusts the number of applications that are replicated when no one is in use.

According to one embodiment, it is possible to provide an autonomous digital companion framework that can easily integrate various AI components developed in each detail in a plug-and-play manner.

### Advantageous Effects

According to one embodiment, it is possible to provide an autonomous digital companion framework that can easily integrate various AI components developed in each detail by a plug and play method.

According to an embodiment, the concept verification for the non-disruptive service of the autonomous digital companion framework may be performed.

According to an embodiment of the present invention, non-disruptive operation may be implemented in a software update and load balancing situation excluding storage and computing.

According to an embodiment, in the autonomous digital companion framework, a plurality of AI components may be Docker-contained to provide an environment for independent and integrated operation management.

According to one embodiment, numerous AI components can be software updated and load balanced without service interruption.

According to an embodiment, the possibility of non-disruptive operation for Docker containerized intelligent components may be verified in advance.

### DESCRIPTION OF DRAWINGS

FIG. 1 illustrates a non-disruptive software update system on container cluster, according to an exemplary embodiment.

FIG. 2 illustrates a container orchestration cluster configuration according to an embodiment.

FIG. 3 illustrates a rolling update according to an embodiment.

FIG. 4 illustrates an AI component of a rolling update process according to an embodiment.

FIG. 5 illustrates a screen UI when a user uses an AI component (nginx) service.

FIG. 6 illustrates load balancing for load balancing of AI components (nginx) services.

FIG. 7 and FIG. 8 illustrate a process in which AI components (nginx) are distributed to the framework and copied into 12.

FIG. 9 illustrates a screen UI when a user uses an AI component (nginx) service.

FIG. 10 illustrates auto scaling for load balancing.

FIG. 11 shows the results using the autoscaler.

### BEST MODE

Specific structural or functional descriptions of the embodiments according to the inventive concept disclosed herein are merely illustrated for the purpose of describing the embodiments according to the inventive concept, and the embodiments according to the inventive concept. These may be embodied in various forms and are not limited to the embodiments described herein.

Embodiments according to the inventive concept may be variously modified and have various forms, so embodiments are illustrated in the drawings and described in detail herein. However, this is not intended to limit the embodiments in accordance with the concept of the present invention to specific embodiments, and includes modifications, equivalents, or substitutes included in the spirit and scope of the present invention.

Terms such as first or second may be used to describe various components, but the components should not be limited by the terms. The terms are only for the purpose of distinguishing one component from another component, for example, without departing from the scope of the rights according to the inventive concept, the first component may be called a second component, Similarly, the second component may also be referred to as the first component.

When a component is said to be “connected” or “accessed” to another component, it may be directly connected to or accessed to that other component, but it is to be understood that other components may exist in between. On the other hand, when a component is said to be “directly connected” or “directly accessed” to another component, it should be understood that there is no other component in between. Expressions describing relationships between components, such as “between ˜” and “immediately between ˜” or “directly neighboring ˜”, should be interpreted as well.

The terminology used herein is for the purpose of describing particular embodiments only and is not intended to be limiting of the invention. Singular expressions include plural expressions unless the context clearly indicates otherwise. As used herein, the terms “including” or “having” are intended to designate that the stated feature, number, step, operation, component, part, or combination thereof is present, but one or more other features or numbers, It is to be understood that it does not exclude in advance the possibility of the presence or addition of steps, actions, components, parts or combinations thereof.

Unless defined otherwise, all terms used herein, including technical or scientific terms, have the same meaning as commonly understood by one of ordinary skill in the technology field to which the present invention belongs. Terms such as those defined in the commonly used dictionaries should be construed as having meanings consistent with the meanings in the context of the related technology, and shall not be construed as ideally or excessively formal meanings unless expressly defined herein.

Hereinafter, exemplary embodiments will be described in detail with reference to the accompanying FIGS. However, the scope of the patent application is not limited or limited by these embodiments. Like reference numerals in the figs denote like elements.

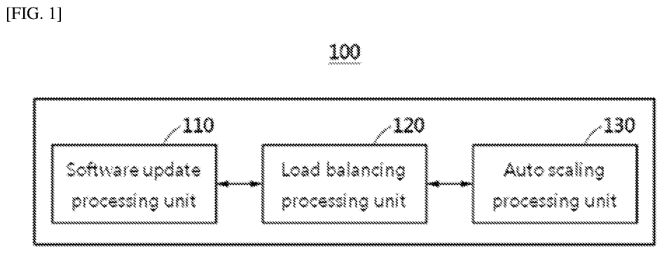

FIG. 1 illustrates a non-disruptive software update system on container cluster(100) according to an embodiment.

The non-disruptive software update system on container cluster(100) according to an embodiment may provide an autonomous digital companion framework that can easily integrate various AI components developed in each detail by a plug and play method. In addition, concept verification for non-disruptive services of the autonomous digital companion framework can be performed, and in the scope of verification, non-stop operation can be implemented in software updates and load balancing situations except storage and computing.

For the above, the container non-disruptive software update system on container cluster(100) according to an embodiment may include a software update processing unit(110), a load balancing processing unit(120), and an auto scaling processing unit(130).

First, the software update processing unit(120) performs a version up through a software patch of the AI component(nginx), but may monitor whether a service is stopped while performing the version up.

In addition, the auto scaling processor unit(130) according to an embodiment increases the number of components when the CPU usage observed in the cloned applications increases beyond the reference value. Conversely, if the CPU usage decreases below the threshold, the number of replicated applications can be reduced.

For the above, the non-disruptive software update system on container cluster(100) can configure a distributed Docker container operating environment for verification and build clusters with container orchestration tools (K8s). In addition, the software update processor(110), the load balancing processor(120), and the auto scaling processor(130) may perform software update of the load balancing for load balancing and the rolling update method for autoscaling and non-disruptive operation after the cluster is built.

According to an embodiment, the auto scaling processor(130) generates an auto scaler for the AI component(nginx). Using this auto scaler, it can apply the minimum and maximum number according to the CPU usage to apply the minimum and maximum number when the CPU is not in use, and to check and adjust the number of applications that are replicated when no one is in use.

Hereinafter, a technology for updating software and performing load balancing without interrupting service on one virtual AI component (nginx) will be described in detail with a specific embodiment.

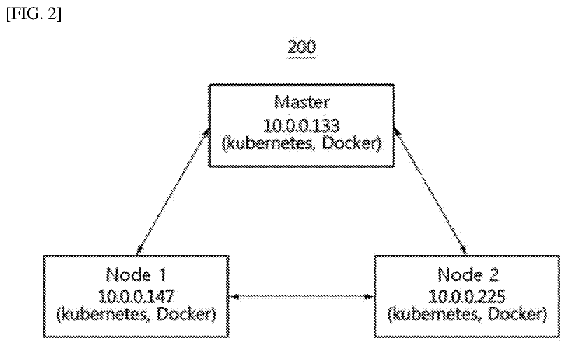

FIG. 2 illustrates a container orchestration cluster configuration 200 according to an embodiment.

In the container orchestration cluster fig(200), the master corresponds to a machine managing the k8s cluster. In addition, a node corresponds to a machine constituting a k8s cluster, and may include a pod including a Docker and a container. Docker is responsible for container execution, pods can be interpreted as a collection of related containers, and is a unit of deployment/operation/management of k8s.

Container orchestration cluster fig according to an embodiment is composed of one master and several nodes. Developers use kubectl to command the master and manage nodes, while users can connect to any of the nodes and use the service. For reference, the kubectl command can be interpreted as a command used to use kubernetes locally.

The master includes api server for work, distributed storage for state management etcd, scheduler, controller manager, etc. Nodes include kubelets that communicate with the master, kube-proxy that handles external requests, and cAdviser for monitoring container resources.

More specifically, Docker is one of the basic requirements of a node, which is responsible for getting and running containers from the Docker image.

Every node in the cluster runs a simple network proxy, which Kube-Proxy can use in the cluster path to request the correct container for the node.

Kubelet is an agent process running on each node that can manage PODs and containers and handle Pod specifications defined in YAML or JSON format. Kubelet can also take a pod specification to check whether the POD is working properly.

Flannel is an overlay network that works when allocating a range of subnet addresses, which can be used to specify the IP of each window running in the cluster and to perform pod-to-pod and pod-to-services communications.

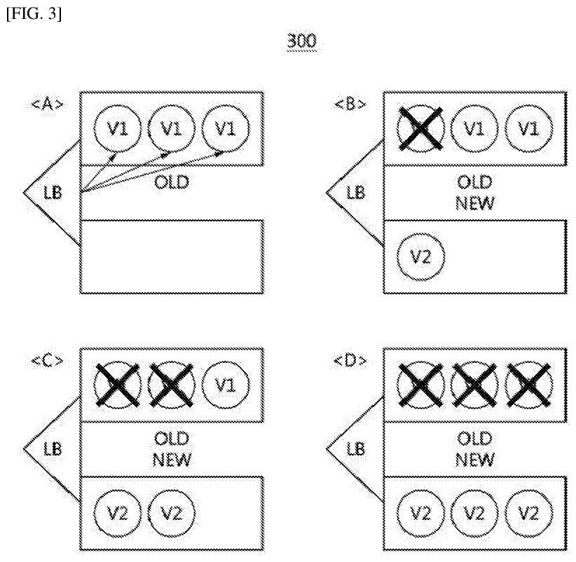

FIG. 3 is a FIG. 300 illustrating a rolling update according to one embodiment.

Non-disruptive software update system on container cluster can check non-disruptive service during version upgrade from v1 to v2 through SW patch of AI component (nginx). In other words, it can check whether the service is working properly during the upgrade from nginx: v1 to nginx: v2, and whether it is naturally supported as nginx: v2 after the upgrade.

As shown by reference FIG. 300, three types of proof of concept (POC) may be performed: load balancing, autoscaling, and rolling update.

The rolling update as a software update can sequentially update the pods n at a time for the processes A to D. The non-disruptive software update system on container cluster can be used to update application versions without disrupting service.

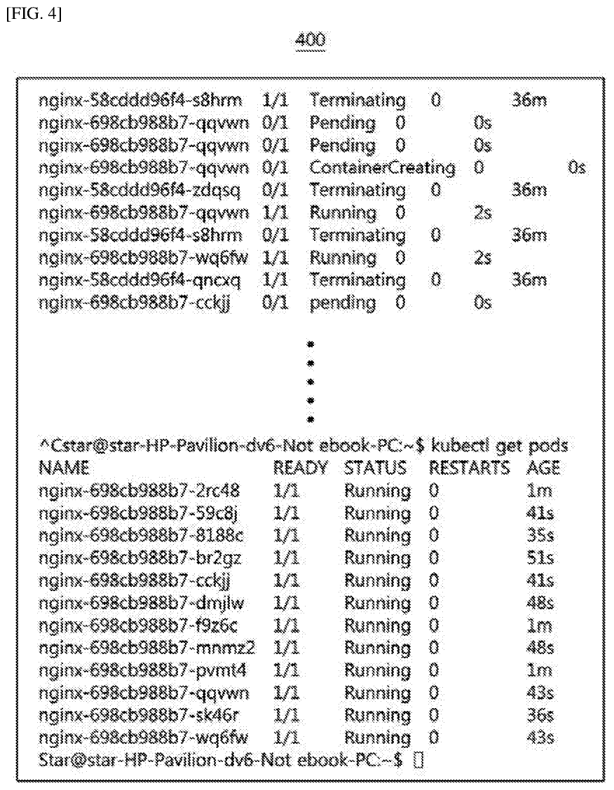

FIG. 4 is a fig representing an AI component of a rolling update process according to an embodiment.

As shown by reference FIG. 400, the AI component in the rolling update process may be updated from AI component nginx: v1 to AI component nginx: v2.

That is, 12 copies of the AI component nginx: v1 are running, and as the AI component nginx: v2 is container created, the AI component nginx: v1 may be terminated.

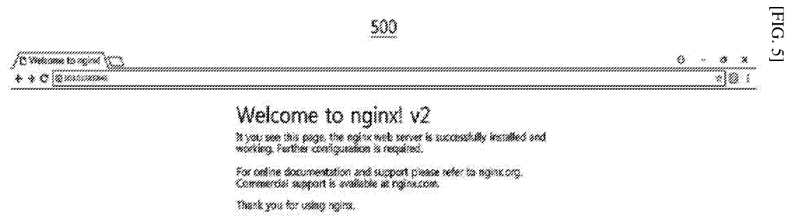

FIG. 5 is a fig illustrating a screen UI when a user uses an AI component (nginx) service.

When the user uses the AI component (nginx) service, ‘Welcome to nginx! v1’ is displayed on the screen, and it can be confirmed that the version has been upgraded to AI component nginx: v2 after the rolling update.

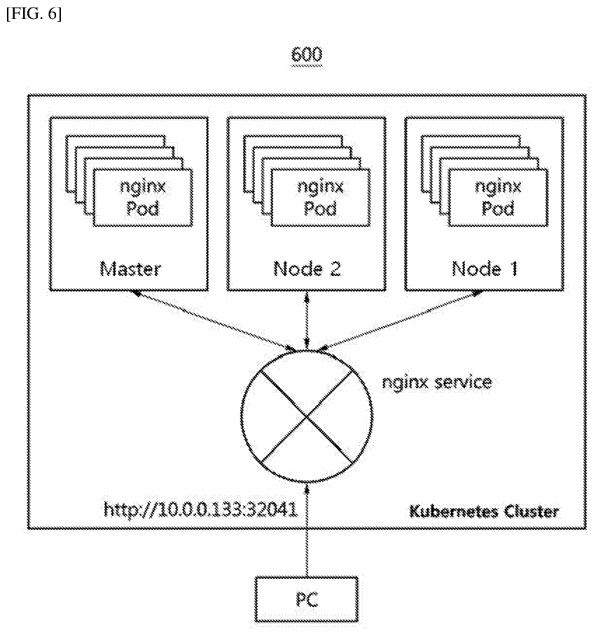

FIG. 6 is a fig(600) illustrating load balancing for load balancing of AI component (nginx) services.

For load balancing for load balancing of AI components (nginx) services, a cluster may be implemented in a structure in which a master and a plurality of nodes are connected to one pc.

Since multiple AI component (nginx) applications are replicated, it is necessary to make sure that users use all the cloned applications when using the service.

A service referred to herein is a collection of pods that do the same thing and can be given a unique or fixed IP address within the k8s cluster. For reference, load balancing can be performed for member pods belonging to the same service.

Specifically, Pods are the basic building blocks of Kubernetes, and Kubernetes is the smallest and simplest unit in the Kubernetes object model that it create or distribute. Thus, a pod can represent a process running in a cluster.

Pods can encapsulate options to manage application containers (or in some cases, multiple containers), storage resources, unique network IPs, and how containers run. That is, a pod is a single application instance of Kubernetes consisting of one container or a few containers that are tightly coupled to share resources.

Pods in a Kubernetes Cluster can be used in two main ways.

For pods running a single container, one container model per pod is the most common Kubernetes use case. In this case, pods can be thought of as wrappers around a single container, and Kubernetes can directly manage pods, not containers.

For pods that run multiple containers that need to be used together, pods can encapsulate an application that consists of containers in multiple locations that are tightly coupled and need to share resources.

These co-located containers can form a single cohesive service unit that serves files publicly on a shared volume, and separate sidecar containers can refresh or update the files. Pods, on the other hand, can group these containers and storage resources together into a single manageable entity.

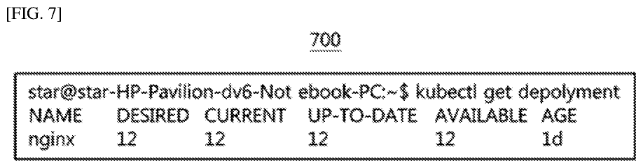

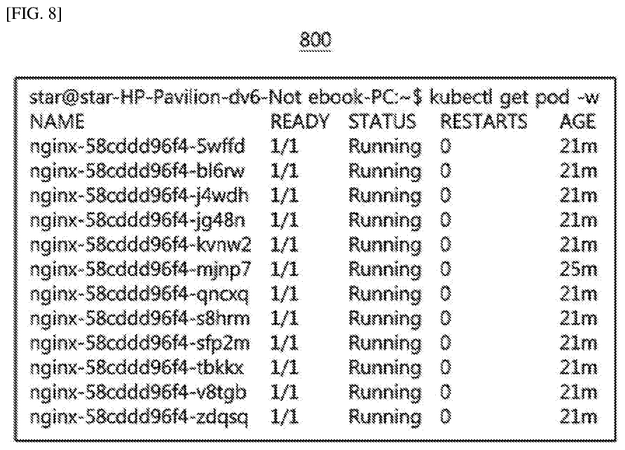

FIG. 7 and FIG. 8 are figs showing how the AI component (nginx) is distributed to the framework and copied into 12.

As shown in FIG. 700 of FIG. 7, it can be seen that 12 duplicate AI components (nginx) whose names begin with nginx are waiting.

As shown in FIG. 800 of FIG. 8, the pods can be duplicated into 12 by distributing AI components (nginx) to the framework. In addition, 12 cloned AI components (nginx) contain their respective pods, and can have names starting with nginx. In this case, the AI components nginx may be displayed in a running state. In addition, each AI component (nginx) is set in age (m) unit can prevent the system from congestion by any one pod.

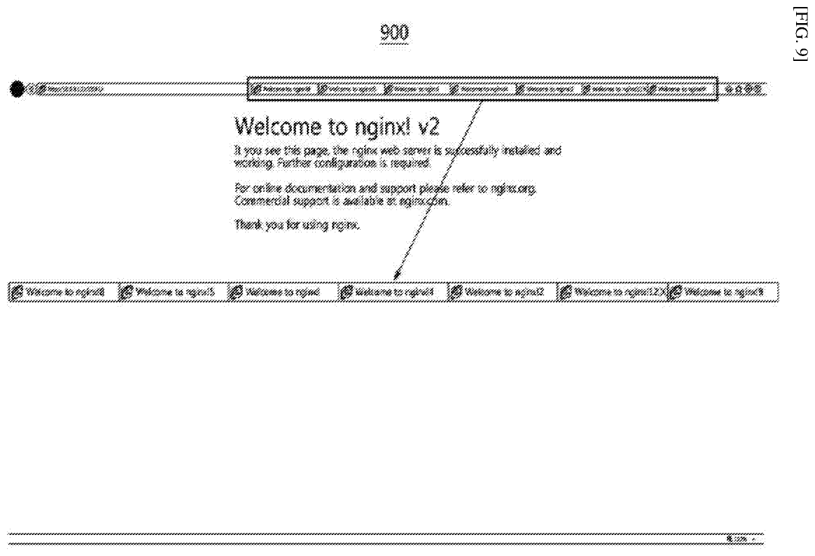

FIG. 9 is a FIG. 900 illustrating a screen UI when a user uses an AI component (nginx) service.

As shown in FIG. 900, the numbers from 1 to 12 can be numbered for replicated applications. The numbered numbers can be shown in the web page title to ensure load balancing by load balancing from 1 to 12.

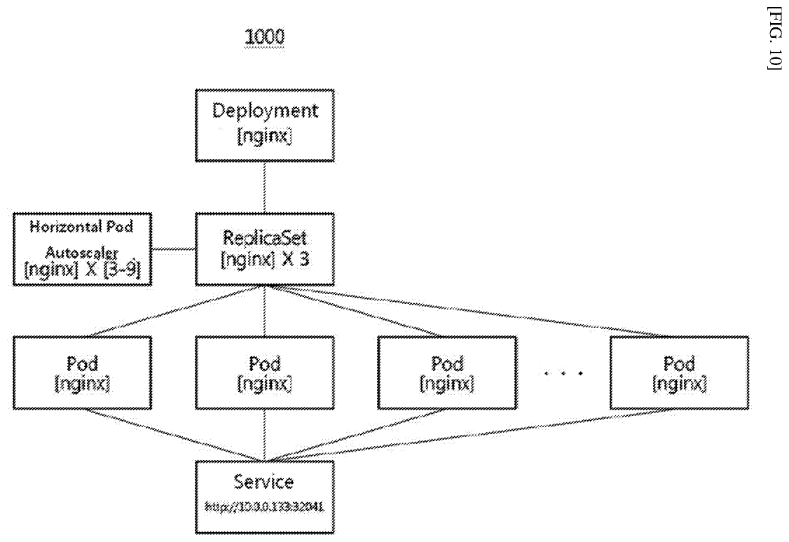

FIG. 10 is FIG. 1000) illustrating auto scaling for load balancing.

According to one embodiment, the non-disruptive software update system on container cluster creates an autoscaler for nginx, a virtual AI container. The autoscaler applies a min-max of the number of replicas based on CPU usage and can see replicas when no one is in use.

The structure of the horizontal pod autoscaler may include a plurality of pods, RC/deployment including scales, and a horizontal pod autoscaler.

Deployment in RC/Deployment is responsible for creating and updating instances of the application. If a Kubernetes cluster is running, it can place container applications on top of it. To do this, it can create a Kubernetes deployment configuration.

With the Horizonal Pod Autoscaler, Kubernetes can automatically adjust the number of pods in a replication controller, deployment, or replica set based on observed CPU utilization.

Instead of the observed CPU utilization, alpha support can also automatically adjust the number of pods in a replication controller, distribution, or replica set based on metrics provided by other applications.

Horizon Pod Autoscalers do not apply to non-scalable objects and can be implemented as Kubernetes API resources and controllers. The resource can determine the controller's behavior, and the controller can periodically adjust the number of replicas in the replication controller or deployment so that the observed average CPU utilization matches the target user specifies.

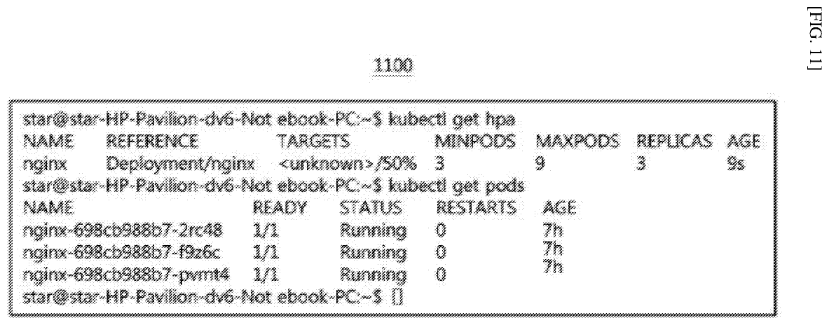

FIG. 11 is a fig showing the result(1100) using the autoscaler.

According to FIG. 1100, the autoscaler shows that the min-max is set to 3-9 when the CPU usage is 50% or more, and the number of copies is 3 when not in use.

As a result, using the present invention, it is possible to provide an autonomous digital companion framework that can easily integrate various AI components developed in each detail by a plug and play method. In addition, concept verification can be performed for non-disruptive services of the autonomous digital companion framework. In addition, the scope of verification enables non-stop operations under software updates and load balancing, excluding storage and computing. In addition, in an autonomous digital companion framework, multiple AI components can be docked into containers to provide an independent and integrated operation management environment.

The apparatus described above may be implemented as a hardware component, a software component, and/or a combination of hardware components and software components. For example, the devices and components described in the embodiments may be, for example, processors, controllers, arithmetic logic units (ALUs), digital signal processors, microcomputers, field programmable arrays (FPAs), It may be implemented using one or more general purpose or special purpose computers, such as a programmable logic unit (PLU), microprocessor, or any other device capable of executing and responding to instructions. The processing device may execute an operating system (OS) and one or more software applications running on the operating system. The processing device may also access, store, manipulate, process, and generate data in response to the execution of the software. For the convenience of understanding, the processing apparatus may be described as one used, but one of ordinary skill in the art may recognize that the processing apparatus may include a plurality of processing elements and/or a plurality of types of processing elements. For example, the processing device may include a plurality of processors or one processor and one controller. In addition, other processing configurations are possible, such as parallel processors.

The software may include a computer program, code, instruction, or a combination of one or more of these. It is also possible to configure the processing device to operate as desired or to command the processing device independently or collectively. The software and/or data may be interpreted by the processing device or to provide instructions or data to the processing device, including any type of machine, component, physical device, virtual equipment, computer storage medium or device, or may be permanently or temporarily embodied in a signal wave to be transmitted. The software may be distributed over networked computer systems so that they may be stored or executed in a distributed method. Software and data may be stored on one or more computer readable recording media.

The method according to the embodiment may be embodied in the form of program instructions that can be executed by various computer means and recorded in a computer readable medium. The computer readable medium may include program instructions, data files, data structures, etc. alone or in combination. The program instructions recorded on the media may be those specially designed and constructed for the purposes of the embodiments, or they may be of the kind well-known and available to those having skill in the computer software arts. Examples of computer-readable recording media include magnetic media such as hard disks, floppy disks, and magnetic tape, optical media such as CD-ROMs, DVDs, and magnetic disks, such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like. The hardware device described above may be configured to operate as one or more software modules to perform the operations of the embodiments, and vice versa.

Although the embodiments have been described by a limited fig as described above, various modifications and variations are possible to those skilled in the relevant technology field from the above description. For example, the described techniques may be performed in a different order than the described method, and/or components of the described systems, structures, devices, circuits, etc. may be combined or combined in a different form than the described method, or other components, or even if replaced or substituted by equivalents, an appropriate result can be achieved.

Therefore, other implementations, other embodiments, and equivalents to the claims are within the scope of the claims that follow.

1. In the non-disruptive software update system required to integrate the developed AI components (nginx) in a plug and play method,
A software update processing unit performing a version up through a software patch of the AI component (nginx) and monitoring whether a service is stopped while performing the version up;
A load balancing processor configured to distribute the load by replicating the application of the AI component (nginx) into a plurality, and monitor the load distribution process; And
An auto scaling processor that increases the number of components when the CPU usage observed in the replicated applications increases above the reference value and decreases the number of replicated applications when the CPU usage decreases below the reference value.

2. The method of claim 1,
The non-disruptive software update system on the container cluster,
configures a distributed Docker container operating environment for verification, build clusters with container orchestration tools (K8s), and roll-update software for load balancing, autoscaling, and non-stop operations for load balancing after the cluster is built. It is characterized by performing an update.

3. The method of claim 1,
The auto scaling processing unit,
creates an autoscaler for the AI component (nginx), apply the minimum number and the maximum number according to the CPU usage using the generated autoscaler, apply the minimum and maximum number when not using the CPU Non-disruptive software update system based on container cluster that checks and adjusts the number of applications that are replicated when no one is in use.
